(19) United States
(12) Patent Application Publication
(10) Pub. No.: US 2009/0091821 A1
(43) Pub. Date: Apr. 9, 2009

(54) OPTICAL SIGHTING DEVICE WITH SELECTIVE LASER WAVELENGTH REMOVAL

(76) Inventor: Rick R. Regan, Aloha, OR (US)

Correspondence Address: STOEL RIVES LLP, 900 SW FIFTH AVENUE, SUITE 2600, PORTLAND, OR, 97204-1268, US

(21) Appl. No.: 12/247,924

(22) Filed: Oct. 8, 2008

Related U.S. Application Data
(60) Provisional application No. 60/978,713, filed on Oct. 9, 2007.

(51) Int. Cl. G02B 17/08; G02B 5/26

(52) U.S. Cl. 359/351

(57) ABSTRACT

An optical sighting device such as a spotting scope, riflescope or binocular having optics that direct the desired visible wavelength light to the eye or other sensor/detector while removing certain undesirable wavelengths such as infrared (IR) or ultraviolet (UV). In one configuration for a spotting scope having two front surface mirrors that fold the optical path to offer greater magnification and performance in a compact housing, the optics are modified by replacing one or both of the mirror surfaces with a band pass mirror, known as a cold mirror, the band pass mirror having particular optical transmission/reflection properties to reflect visible light and pass the undesirable wavelengths. Alternately, in a system employing a prism, one or more of the internal reflection surfaces may be formed with a desired coating for removing the IR wavelength light.

This application claims priority to provisional application No. 60/978,713 filed Oct. 9, 2007, hereby incorporated by reference.

### BACKGROUND

The field of present disclosure relates to optical sighting devices such as spotting scopes, riflescopes, binoculars, monoculars, and optical protection systems and devices therefore.

Lasers are increasingly found in various military, law enforcement and hunting applications for range finding, tactical illumination (e.g., aiming) and target designation. The human eye, as well as optical sensors/detectors and photo receptors can be damaged by exposure to high intensity light. For example, the retina of the eye and the nearby nerves may be damaged when exposed to a laser beam for only a short time. The irradiance of the laser energy perceived by the eyes, and hence the potential for eye damage, is increased when a user employs a spotting scope, binoculars or similar visual telescopic instrument because the laser light is focused by these magnification devices and thus a greater intensity of such laser light reaches the eyes. The present inventor has recognized the potential hazard of using a spotting scope or other optical devices where an intense laser radiation is present.

Current laser eye protection methods for visual optics involve placing a filter for attenuating the intensity of laser wavelength light from the visible wavelengths in the optical path of the optics. These filters are placed either in front of or just behind the objective lens of the optics and are either reflective or absorptive filters or an optic with an ablative coating. The present inventor has determined that visible light transmission through either type of filter is typically reduced by more than 10 percent, and with light transmission loss through a typical high-quality observation or targeting device, there is an additional 10 percent loss. Therefore a combined loss of greater than 20 percent would be experienced in that approach.

### SUMMARY

The present invention is directed to optical sighting devices. In a preferred embodiment, the optical sighting device includes optics that direct the desired visible wavelength light to the eye or other sensor/detector while removing certain undesirable wavelengths such as IR or UV. A preferred configuration may utilize a spotting scope having two front surface mirrors that fold the optical path to offer greater magnification and performance in a compact housing. This two mirror spotting scope is modified by replacing one or both of the mirror surfaces with a band pass mirror, known as a cold mirror, having particular optical transmission/reflection properties to reflect visible light and pass the undesirable wavelengths.

### BRIEF DESCRIPTION OF THE DRAWINGS

FIG. 1 is a diagram of a spotting scope lens system according to a first embodiment employing two front surface mirrors folding the optical path.

FIG. 2 is a graph of the reflective properties for a preferred broadband dielectric reflector for the spotting scope of FIG. 1.

FIG. 3 is a graph of the transmittance properties for a preferred cold mirror of the spotting scope of FIG. 1.

FIG. 4 is a diagram of an alternate spotting scope or riflescope lens system employing a roof prism.

### DETAILED DESCRIPTION OF PREFERRED EMBODIMENTS

Preferred embodiments will now be described with reference to the drawings. The preferred embodiments will be described in terms of a lens system for a spotting scope, but alternate embodiments may be employed within binoculars, monoculars, riflescopes and other types of optical viewing mechanisms.

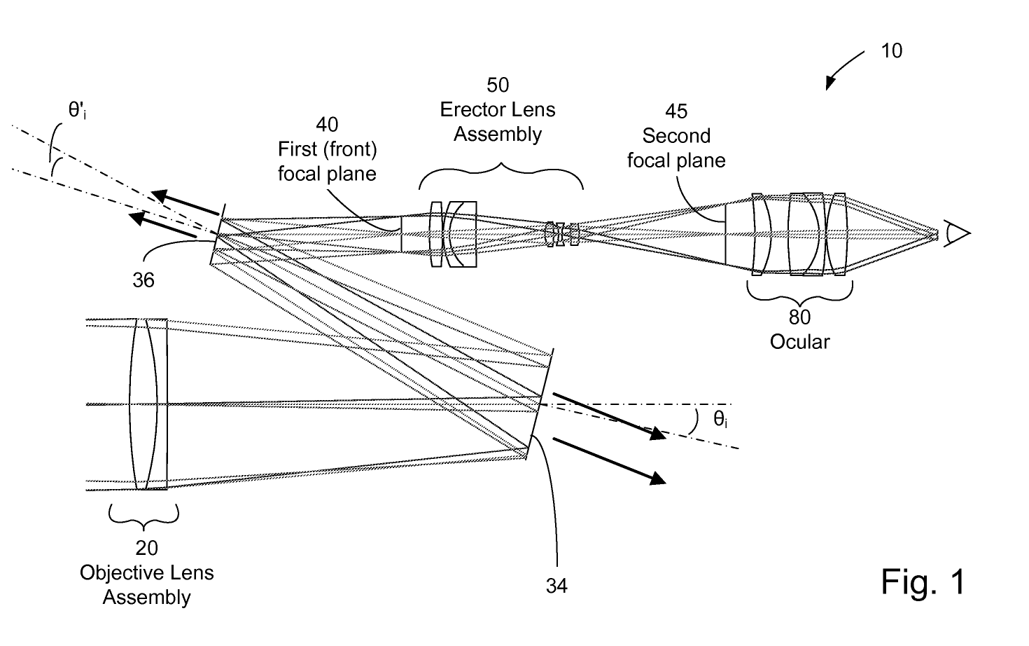

FIG. 1 illustrates a first preferred embodiment of a lens assembly 10 for a spotting scope comprised of an objective lens assembly 20 for focusing an object in a field of view to an image at a first focal plane 40; first and second mirrors 34, 36 for folding the optical path; an erector lens assembly 50 or alternate erector system (e.g., prisms) inverting the image and focusing it to a second focal plane 45; and an ocular 80 forming an image for the eye of the user. The optical layout of this spotting scope is based generally on the variable power 12−40×60 mm spotting scope available from Leupold & Stevens, Inc. of Beaverton, Oreg.

In this lens assembly 10, one or both of the mirrors 34, 36 is replaced with a cold mirror, a dichroic reflector which functions as a broadband interference optic. In a preferred configuration, the cold mirror 34 includes a glass plate or other substrate coated on its front surface with a dielectric film stack. The cold mirror optic is selected to have specific optical properties to (1) reflect the visible light spectrum and (2) pass light of certain near infrared and infrared (IR) wavelengths. The cold mirror 34 reflects virtually all the visible light spectrum while allowing the specific near IR and IR spectrum light to pass through. The typical reflectivity of a cold mirror for visible light is about 96%, which yields a 4% loss in intensity. In contrast, a band pass filter located within the optical path to remove infrared light would typically introduce a 10% loss in the intensity of the visible light passing through the optical system.

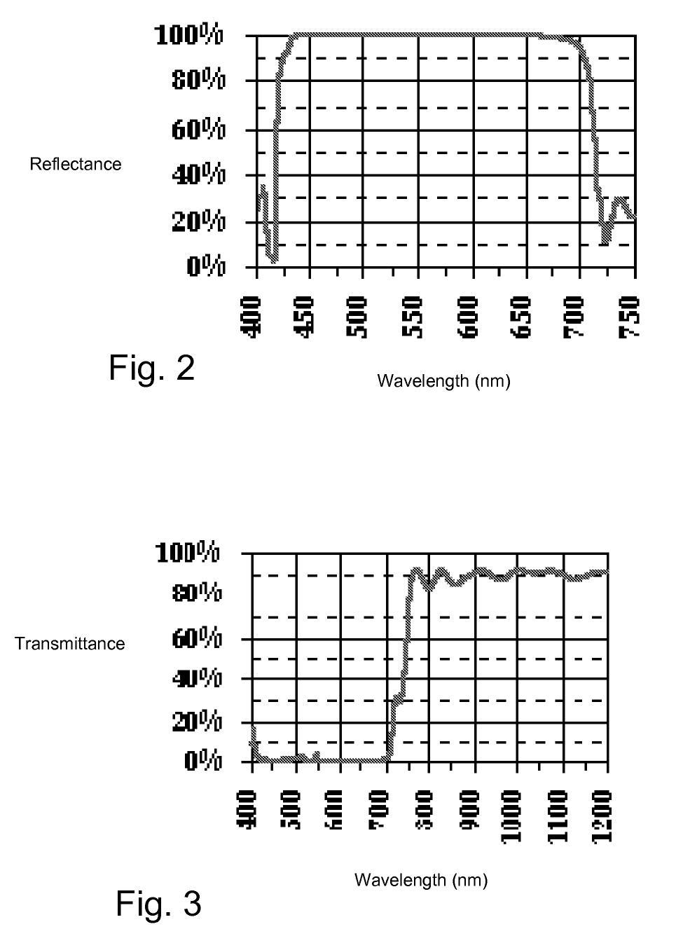

A cold mirror may be defined by its transmissive and reflective properties. FIG. 2 is a graph of the reflective properties of a preferred cold mirror and FIG. 3 is a graph of the transmittance properties of a preferred cold mirror. Employing this cold mirror as the reflector 34 and/or reflector 36, greater than about 90% of the visible light between 450 nm and 700 nm is reflected by the mirror (and along the desired optical path and on the order of 85% or more of the IR radiation between 725 nm and 1200 nm is transmitted through the mirror and thus is not reflected. It is understood that the higher (greater than 1200 nm) wavelength IR radiation is also transmitted through the mirror. Thus the cold mirror having these properties of high reflectance in the visible range and low reflectance in specific IR range may be utilized for reducing the amount of IR radiation reaching the eye of the user while maintaining low loss levels in the visible range.

In an alternate configuration, both mirror 34 and mirror 36 may comprise cold mirrors. In such a configuration, the intensity loss will be somewhat higher than the single cold mirror combination. For example, presuming a 4% loss in the visible light wavelength, combined reflectivity would be 96%×96%=92.16%. However, by providing the reflective surfaces of both mirrors 34 and 36 being cold mirrors, combined reflectivity for IR wavelength light would be 15%×15%=2.25%. Thus for the dual cold mirror system, on the order of 97.75% of the IR light is prevented from reaching the ocular 80 via operation of the two cold mirrors 34, 36.

In the dual cold mirror configuration, the mirrors 34, 36 may comprise the same or similar dielectric coatings or each mirror may comprise a different coating having unique optical properties or reflectivity frequency response. For example, one of the mirrors may effectively remove IR wavelength light (e.g., 85% transmissive) at 725 nm +/−5 nm while the other mirror may effectively remove IR wavelength light (e.g. 85% transmissive) at 750 nm ±5 nm. In another example, one mirror may have a lower removal percentage in a band at a particular wavelength as in the following table:

TABLE A

| | IR Reflectivity @ 725 nm | IR Reflectivity @ 750 nm |
|---|---|---|
| Mirror A | 50% | 20% |
| Mirror B | 15% | 45% |
| Total: | 7.5% | 9% |

Thus by way of two mirrors, the Mirror A compensates for the removal deficiency of Mirror B at the 750 nm band and Mirror B compensates for the removal deficiency of Mirror A at the 725 nm wavelength band whereby in excess of 90% of IR light intensity is removed at each of the 725 nm and 750 nm wavelength bands. Thus by a combination of cold mirrors, a high range (greater than 90%) or ultra high range (greater than 95%) of IR light across the IR spectrum may be removed.

The coating is selected/designed depending upon several factors, including: mirror materials, the angle of incidence θᵢ, and the wavelengths of the light desired to be removed.

In a preferred single cold mirror configuration, it is preferred that the cold mirror transmit (and thus remove from the optical path) at least 70% or 80% of IR light from 725 nm to 1200 nm (or 750 nm and 1100 nm). Some of the common laser devices applications include: YAG laser (1500 nm and 1064 nm) typically used in military vehicle applications; and laser diodes (905 nm and 808 nm) typically used for laser rangefinder applications. By removing the IR light of this wavelength range, laser light produced by these laser devices is removed.

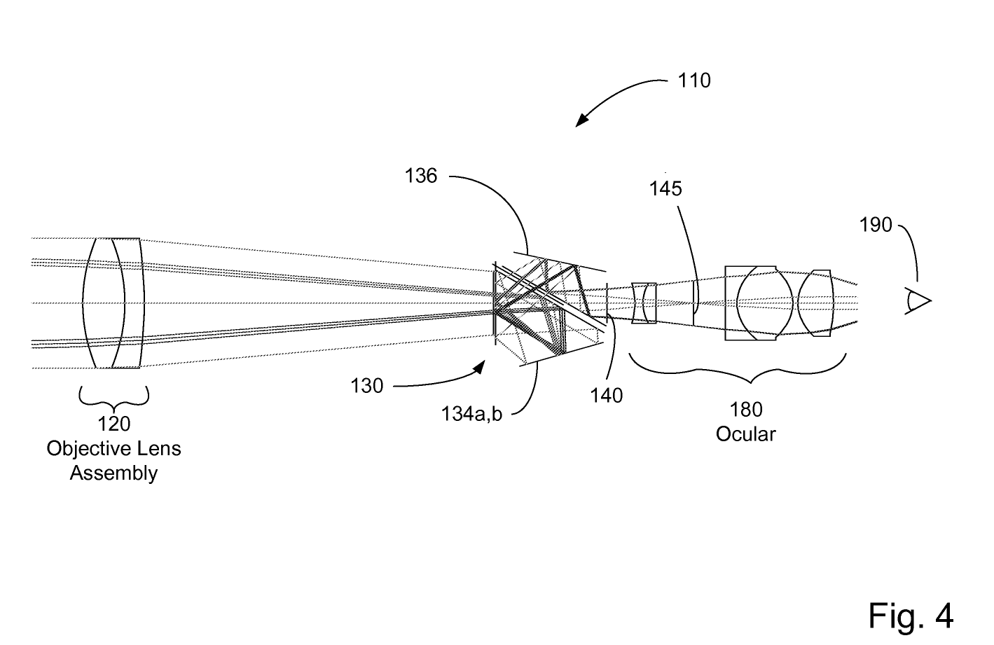

FIG. 4 illustrates an alternate embodiment of a lens assembly 110 that may be particularly useful for a binocular, spotting scope or riflescope. This optical layout is based on a configuration that supports binoculars, spotting scopes and riflescopes available from Leupold & Stevens, Inc. of Beaverton, Oreg., but according to a preferred embodiment, the roof prism is modified as described in the following. As modified, the binocular is comprised of an objective lens assembly 120 for focusing an object in a field of view to an image at a focal plane 145; a roof prism 130 for inverting the image 140; and an ocular lens assembly 180 for focusing and forming an image for the eye of the user 190.

The roof prism 130 illustrated in FIG. 4 is in the form of a modified Schmidt-Pechan prism. The prism 130 includes six internal reflective surfaces 136 and 134a, 134b with one or more of these reflective surfaces comprising cold mirrors of similar optical properties as described in the previous embodiment. It is noted that in FIG. 4 the roof mirrors 134a, 134b are not separately illustrated. The cold mirror reflects light of wavelengths in the visible range with high efficiency and allows light in the IR wavelength range (about 85%) to pass through effectively removing a large portion of the IR light from the optical path. Reflective surface 136 may be a preferred surface for a single cold mirror application, but by including cold mirrors at both surfaces 134a, 134b with each surface passing 85% of IR light, a combined 97% of the IR light intensity may be removed.

Other types of prisms may be employed with dielectric coatings on certain surfaces to serve as a cold mirror. A Porro prism may have two reflective surfaces that may accommodate a dielectric coating. A double Porro prism may have four reflective surfaces suitable for dielectric coating. An Abbe-Koenig prism may have two reflective surfaces for dielectric coating. An Amici prism is another type of roof prism having one reflective surface that may be suitable for dielectric coating.

The undesirable IR wavelength light that is transmitted through the cold mirror is preferably routed to a black body behind the cold mirror, the black body designed to absorb or trap the IR light. Since the IR light is likely not to be a sustained pulse, it is expected that the total energy of the IR radiation will be somewhat low and thus should not generate significant heat.

Thus preferred optical systems and configurations have been shown and described. While specific embodiments and applications for have been shown and described, it will be apparent to one skilled in the art that other modifications, alternatives and variations are possible without departing from the inventive concepts set forth herein. Therefore, the invention is intended to embrace all such modifications, alternatives and variations.

1. An optical sighting device such as a spotting scope, riflescope or binocular, comprising an optical system defining a folded optical path, the optical system including at least a first cold mirror constructed and arranged to remove infrared light from the optical path by (a) reflecting a predominant portion of light in the visible range along the optical path and (b) transmitting a predominant portion of light in at least a portion of the infrared range.

2. An optical sighting device according to claim 1 wherein the first cold mirror removes from the optical path in excess of 70% of infrared light between 750 nm and 1100 nm.

3. An optical sighting device according to claim 1 wherein the first cold mirror reflects in excess of 95% of visible light between 450 nm and 650 nm.

4. An optical sighting device according to claim 1 wherein the optical system further includes a second cold mirror constructed and arranged to (a) reflect a predominant portion of light in the visible range along the optical path and (b) transmit a predominant portion of light in at least a portion of the infrared range.

5. An optical sighting device according to claim 4 wherein the first cold mirror and the second cold mirror combine to remove from the optical path in excess of 90% of infrared light between 750 nm and 1100 nm.

6. An optical sighting device according to claim 4 wherein the first cold mirror and the second cold mirror combine to remove from the optical path in excess of 95% of infrared light between 750 nm and 1100 nm.

7. An optical sighting device according to claim 4 wherein optical system comprises a roof prism modified wherein each of the first and second cold mirrors comprises a reflective surface of the prism.

8. An optical sighting device according to claim 6 wherein the roof prism comprises a Schmidt-Pechan prism.

9. An optical sighting device according to claim 1 further comprising a black body positioned behind the first cold mirror for absorbing or trapping infrared light passing through the first cold mirror.

10. An optical sighting device according to claim 1 wherein the optical system comprises a prism, wherein the first cold mirror comprises one reflective surface of the prism having a dielectric coating.

11. An optical sighting device according to claim 1 wherein the optical prism is selected from the group consisting of: a roof prism, a Porro prism, double Porro prism, an Abbe-Koenig prism, an Amici prism, a Schmidt-Pechan prism.

12. An optical sighting device such as a spotting scope, riflescope or binocular, comprising an optical system defining a folded optical path, the optical system including a prism, the prism having a plurality of reflective surfaces, wherein at least one of the reflective surfaces a dielectric coating operative to remove infrared light from the optical path by (a) reflecting a predominant portion of light in the visible range along the optical path and (b) transmitting a predominant portion of light in at least a portion of the infrared range.

13. In an optical sighting device such as a spotting scope, riflescope or binocular comprising an optical system defining a folded optical path toward an ocular, a method of removing infrared light from the reaching the ocular comprising the steps of
providing at least a first cold mirror in the optical path;
using the first cold mirror (a) to reflect a predominant portion of light in the visible range along the optical path and (b) transmit a predominant portion of light in at least a portion of the infrared range.

14. A method according to claim 13 further comprising
providing a second cold mirror in the optical path (a) to reflect a predominant portion of light in the visible range along the optical path and (b) transmit a predominant portion of light in at least a portion of the infrared range.

15. A method according to claim 14 wherein the first cold mirror and the second cold mirror combine to remove from the optical path in excess of 90% of infrared light between 750 nm and 1100 nm.
